(19) United States
(12) Patent Application Publication
(10) Pub. No.: US 2020/0072192 A1
(43) Pub. Date: Mar. 5, 2020

(54) METHOD FOR CONTROLLING A WIND TURBINE

(71) Applicant: Wobben Properties GmbH, Aurich (DE)

(72) Inventors: William MELI TIWA, Hamburg (DE); Volker DIEDRICHS, Bad Doberan (DE); Stefan GERTJEGERDES, Aurich (DE)

(21) Appl. No.: 16/467,738

(22) PCT Filed: Dec. 19, 2017
(86) PCT No.: PCT/EP2017/083501

§ 371 Date: Jun. 7, 2019

(30) Foreign Application Priority Data
Dec. 20, 2016 (DE) 10 2016 125 045.7

(51) Int. Cl. F03D 7/02

(52) U.S. Cl. CPC F03D 7/0224; F03D 7/024

(57) ABSTRACT

A method for controlling a wind power installation, wherein the wind power installation has an aerodynamic rotor with rotor blades that are individually adjustable in their blade angle and the rotor can be operated with a variable rotational rotor speed, and the wind power installation has a generator coupled to the aerodynamic rotor, for generating a generator output, comprising the steps of: individually adjusting each blade angle in a way corresponding to an individual setpoint blade angle, wherein each setpoint blade angle is made up of a common basic angle, which is specified for all of the rotor blades, and an individual compensatory angle, to allow for individual load torques, detecting in each case at least one load torque on each of the rotor blades, or a variable that is representative of this, wherein for each rotor blade considered, there is a preceding rotor blade and the setpoint blade angle of each rotor blade considered is determined in dependence on the at least one load torque of its preceding rotor blade.

### BACKGROUND

### Technical Field

The present application relates to a method for controlling a wind power installation. The present invention also relates to a corresponding wind power installation.

### Description of the Related Art

Wind power installations are known and they generate electrical energy from wind. For this, such a wind power installation usually has an aerodynamic rotor with at least one rotor blade, usually three rotor blades. The rotor blades are fastened to a hub, which is part of the rotor, and the rotor is mounted in a machine cabin or nacelle. The machine cabin or nacelle is rotatably mounted on a tower, occasionally also on a mast, and can be aligned into the wind. During the operation of the wind power installation, the wind also produces a loading. This loading acts inter alia on the rotor blades, the hub, a mounting of the rotor in the nacelle, on the mounting of the nacelle on the tower and lastly also on the tower itself.

To reduce such loads, particularly at wind speeds above a nominal wind speed, but also in ranges below that, the rotor blades are adjusted such that only nominal output is generated by the wind power installation. This is in any event a procedure that is adopted in the case of wind power installations which have rotor blades that are adjustable in their blade angle.

At still higher wind speeds, load relief is also achieved by not only keeping the output to the nominal output but also lowering it to below the nominal output, and the rotational speed is often also reduced. In this way it is intended to achieve the overall effect of reducing the loading of the wind power installation.

It is of course undesirable in principle to reduce the output of the wind power installation when there is strong wind, because this also involves a loss of yield. Particularly at high wind speeds, even approaching storm force, there is often also the issue that not only is the wind strong but it often also includes many strong gusts. The wind is therefore then subject to particularly strong fluctuations.

In order to prevent overloading of the wind power installation even when there are fluctuating wind speeds, when there are fluctuating wind speeds it is often controlled or set to the greatest wind speed in each case. This can lead to the problem that the loss of yield is greater than necessary.

There is often also the issue that a modern wind power installation passes over a very large rotor area, which may have a diameter of 100 meters or more. Correspondingly, there are also great differences in height and, possibly associated with that, corresponding differences in the wind speed in the rotor area at the same time. Local wind field differences, including turbulences, within the rotor area may also occur.

In order to make allowance for such local variations within the rotor area, an individual blade adjustment in which the rotor blades adjust their blade angles individually has already been proposed. This can achieve the effect that the rotor blades can be set to different conditions on the basis of their different positions during their rotation. Such a method is disclosed for example in the document U.S. Pat. No. 6,361,275.

But even such methods are unable to foresee different loadings in the rotor area. To remedy this, an improved and dedicated detection of the wind field may be provided, for example by Lidar or Sodar. However, such measures, or the equipment necessary for them, are often very costly.

The German Patent and Trademark Office has searched the following prior art in the priority application for the present application: DE 10 2008 031 816 A1, US 2014/0178197 A1, EP 2 607 689 A2, WO 2009/033484 A2 and WO 2015/192852 A1.

### BRIEF SUMMARY

A wind power installation that can react in an improved manner to loadings due to the wind with allowance for local and temporal variations is provided.

A method is proposed. Such a method for controlling a wind power installation is based on a wind power installation which has an aerodynamic rotor with rotor blades that are individually adjustable in their blade angle. Therefore, for example, at least one adjusting drive for adjusting the blade angle is provided for each rotor blade and moreover can in principle be individually activated, so that an individual blade angle can be respectively set for each rotor blade. The adjusting of the rotor blade in its blade angle is usually also referred to as pitching. Correspondingly, the at least one drive in each case is a pitch drive.

Furthermore, the rotor can be operated with a variable rotational rotor speed. This particularly means that the rotational rotor speed can also be chosen and set demand-dependently.

For generating a generator output, also provided is a generator, which is coupled to the aerodynamic rotor. Particularly coming into consideration for this is a direct coupling, so that a rotation of the aerodynamic rotor corresponds to a rotation of an armature of the generator. In the case of such a gearless system, the armature of the generator is fixedly connected to the aerodynamic rotor. In principle, however, the use of a gear mechanism between the aerodynamic rotor and the armature of the generator also comes into consideration. The term armature is used here to differentiate from the aerodynamic rotor, irrespective of the type of generator used.

The method for controlling a wind power installation thus proposes as one step an individual adjustment of each blade angle in accordance with an individual setpoint blade angle. Therefore, a setpoint blade angle is specified for each rotor blade, and consequently for each blade angle, and these setpoint blade angles may be different.

Each of these setpoint blade angles is made up of a common basic angle, which is specified for all of the rotor blades, and an individual compensatory angle, to allow for individual load torques, or is made up of variables that are representative of these angles, such as for example a bending torque at the connection of the rotor blade. The common basic angle is consequently the same for all of the rotor blades and is also commonly specified for them. It may already be specified at each pitch drive, or else initially be further processed centrally. In addition to the common basic angle there is an individual compensatory angle, which is provided to allow for individual load torques. The determination, in particular calculation, of each individual compensatory angle consequently takes place by producing in each case an individual setpoint angle that can be used to allow for the individual load torques. To this extent, it is proposed that they are specified in a manner dependent on the loading. However, that does not preclude allowance also being made for other criteria. Preferably, the individual compensatory angle is also determined such that not only is a reduction of the load performed, but also, as far as possible, an excessive loss of yield is avoided.

It is then also proposed that in each case at least one load torque is detected on each of the rotor blades. Particularly, load measurements may be provided on each rotor blade. For this purpose, sensors may be provided on the blade or the blade root, or for example a movement or deflection of the rotor blade may also be evaluated. Allowance for multiple input variables for detecting each of these load torques also comes into consideration.

For this purpose, it is also proposed that, for each rotor blade considered, there is a preceding rotor blade and the setpoint blade angle of each rotor blade considered is determined in dependence on the at least one load torque of its preceding rotor blade. Particularly, a rotor with three rotor blades is provided, a different number also coming into consideration; and in this example of the rotor with three rotor blades, the rotor blades are respectively arranged offset by 120° in relation to one another in the circumferential direction. Consequently, during the rotation of the rotor, a second rotor blade always follows a first rotor blade by 120°, it being possible for each of the rotor blades to be the first rotor blade and each of the rotor blades to be the second rotor blade, and moreover it also being possible for each of the rotor blades to be a third rotor blade.

It is thus proposed that, to stay with this example, the setpoint blade angle, to be specific in particular the compensatory angle, of this second rotor blade taken by way of example is determined in dependence on a load torque of the first rotor blade mentioned by way of example. This is based on the idea that, due to the rotation of the rotor, the second rotor blade will, with a high degree of probability, shortly encounter more or less the local wind situation of the first rotor blade, to be specific when this second rotor blade reaches the position of the first rotor blade. Particularly, it can also be expected that this second rotor blade will substantially experience the loading that this first rotor blade experienced shortly before. It should be remembered in this respect that the loading that the respective rotor blade experiences also depends on the respective blade state of the respective rotor blade. If the first and second rotor blades mentioned have the same state, which is only assumed here to simplify the explanation, they experience approximately the same loading in the same wind situation. Such blade states could comprise a blade angle, or structural deflecting states, that is to say for example a flexure of the blade.

The directly detected loading of a rotor blade is consequently used directly for the determination of the setpoint blade angle of the rotor blade following it.

It should be emphasized that to this extent not only a consideration of the loading of the preceding rotor blade is proposed here, but also allowance is made for it directly and at the specific time for the blade angle of the following rotor blade. The setpoint blade angles, particularly the individual compensatory angles, are therefore determined and changed directly in a manner dependent on the loading, but not using their own detected loading but instead the loading of the rotor blade preceding them.

Preferably, an angle trajectory is determined for determining each compensatory angle, the compensatory angle being in each case an element of the angle trajectory, so that the angle trajectory respectively indicates a continuous, particularly a steady, in particular continuously differentiable, progression of the respective compensatory angle. The angle trajectory therefore indicates the progression of the respective compensatory angle, and is therefore made up of the compensatory angles. The compensatory angle is in each case an element of the angle trajectory, to be specific in each case at each point in time considered or at each rotor position considered. Correspondingly, the setpoint blade angle of each rotor blade changes in accordance with this angle trajectory. In other words, the setpoint blade angle is made up in each case of the common basic angle and the respectively relevant value of the angle trajectory. Alternatively, the angle trajectory may already comprise the common collective blade angle. The setpoint angle may therefore already be made up in the angle trajectory, or be made up later from the respective value of the angle trajectory and the basic angle.

The determination of the compensatory angles, and consequently the setpoint angles, takes place in the course of operation in dependence on the loading of the preceding rotor blade, without however confining itself in each case to an individual calculation of the individual angle in dependence on the blade loading and continually repeating this. Rather, an overall progression of the setpoint angle is proposed, at least for a certain region. Particularly, in this way allowance is also made for previous setpoint blade angles, which for example were to be set a few degrees ahead with respect to the rotational movement of the rotor. Particularly, it is also proposed not to use expressly the previous set blade angle but instead, to put it clearly, the previous intended blade angle.

By specifying such an angle trajectory in this way, consequently a progression of the setpoint angle, and consequently also substantially a progression of the angle that is then actually set, can be specified. As a result, for example, unnecessarily great or quick adjustment commands to the pitch drive can also be avoided. In return, the angle trajectory is continuous, that is to say has no gaps. It is preferably continuous, that is to say has no sudden discontinuities, and is in particular also continuously differentiable, that is to say also has no breakpoints.

In this way it is possible to provide an adjustment for lowering blade loading that is anticipatory for each rotor blade and moreover, although it is individual and can be carried out continually, can avoid excessive loading of the pitch drives.

According to one embodiment, it is proposed that the angle trajectory is determined in at least two steps. In this case, in a first step, an optimum angle trajectory that is optimized with respect to at least one first design criterion is determined. It also comes into consideration to optimize the optimum angle trajectory with respect to multiple first design criteria. This produces an optimum angle trajectory that is optimized with respect to this one design criterion or the multiple first design criteria but possibly is not practicable in every aspect.

It is correspondingly proposed in a second step to alter this optimum angle trajectory that was determined in said first step to an adapted angle trajectory, while making further allowance for a second design criterion. This may also take place while making further allowance for multiple second design criteria. In other words, the optimum angle trajectory of the first step is altered in the second step into a feasible angle trajectory.

Preferably, the angle trajectory, in particular the optimum angle trajectory, is determined by way of the solution to an optimization problem. This optimization problem is based at least on the at least one first design criterion or multiple first design criteria. The angle trajectory may consequently be the solution to an optimization problem, particularly an optimization problem with constraints. A method according to Lagrange may for example be used for this, particularly the method of Lagrange multipliers. It also comes into consideration to use Karush-Kuhn-Tucker (KKT) conditions as a generalization of the Lagrange multipliers.

Preferably taken as a basis as first design criteria are a reduction of the load, a neutrality of the yield and a preservation of the pitch drive. Therefore, a determination of the optimum angle trajectory takes place by way of the solution to an optimization problem that is based on the three design criteria mentioned. This may preferably mean that the optimum angle trajectory is optimized with regard to the reduction of the load, and that the neutrality of the yield and the preservation of the drive represent constraints for this optimization problem. The optimum angle trajectory is therefore determined in this first step such that a mechanical load is reduced, while neutrality of the yield and preservation of the pitch drive are ensured. A reduction of the load may be a reduction of the loading of the rotor blades, particularly in the region of the hub or the root region of the rotor blades. However, allowance for the loads acting on other elements of the wind power installation also comes into consideration, such as for example a load acting on the hub and the rotor bearing or a load acting on an azimuth bearing of the wind power installation. A load on a tower of the wind power installation also comes into consideration.

If allowance is made for the neutrality of the yield as a constraint, or it is allowed for in some other way, this means that the angle trajectory is determined such that the overall yield of the wind power installation is not reduced, or at least as far as possible is not reduced. This means particularly that the yield on average is not reduced. It may therefore be reduced for a short time, if this reduction is balanced out again. It also comes into consideration that a yield caused by each individual rotor blade changes, particularly cyclically, but the sum of all three rotor blades, if the wind power installation has three rotor blades, altogether is not reduced. The neutrality of the yield may also mean substantially no change of the yield in comparison with the reference case, in which no individual blade adjustment is carried out. Weaker weighting of the neutrality of the yield may mean both a possible slight reduction and an improvement in the yield. This is so because the method may be set for smoothing the progression of the rotational speed and ultimately for optimizing the yield.

Preservation of the drive may mean that the pitch drive is operated as little as possible, with the lowest possible rotational speed and/or with the lowest possible rate of adjustment. Preservation of the drive may be used as a constraint to allow for the behavior of the drive. In this case, both its dynamics and limits can be explicitly included in the solution to the optimization problem. This measure makes an adaptation of the method possible, for example if the blade drives are running to the point of saturation, which can lead to changed dynamics and/or a changed limit.

Allowance for preservation of the drive as a constraint, or in some other way, may be reflected in a time-dependent progression of the angle. With the known rotational rotor speed, which may also be variable here, the time-dependent progression of the blade angle can be transformed directly into an angle trajectory, and vice versa. To this extent, it is pointed out here that an angle trajectory is the progression of the blade angle concerned with respect to the rotational position of the rotor at which the blade concerned is fastened.

To sum up, therefore, in the first step described, the optimum angle trajectory can be determined such that it leads to a reduction of the load, while on average the yield of the wind power installation is not reduced and at the same time the optimum angle trajectory can also be implemented by the pitch drive concerned. This optimum angle trajectory of this first step is then optimal with respect to the reduction of the load while making allowance for neutrality of the yield and preservation of the drive as constraints.

In principle, it also comes into consideration that allowance is not made for all of the design criteria mentioned or allowance is made for other design criteria. For example, in addition or as an alternative, for example as an alternative to the neutrality of the yield, allowance may be made for the sign-sensitive summation of the individual compensatory angles of all of the rotor blades of the wind power installation, that is to say for example all three rotor blades of the wind power installation, always to give the value zero, to name just one example.

Also or alternatively, it is proposed that the drive dynamics of the pitch drive and also or alternatively limit values of the pitch drive respectively form a second design criterion. These second design criteria in the drive dynamics of the pitch drive and/or the limit values of the pitch drive may then be allowed for in the second step, in which the optimum angle trajectory determined in the first step is altered to an adapted angle trajectory.

The allowance for the drive dynamics of the pitch drive includes for example allowing for the fact that the pitch drive concerned cannot implement each angle change as quickly as may be desired. This may mean for example that the optimum angle trajectory is changed as a result, at least to some extent in its dynamics. For example, abrupt changes that were provided in the optimum angle trajectory may be lessened, so that they can then also realistically be implemented by the pitch drive.

Particularly maximum rotational speeds or else maximum accelerations of the pitch drive or the resultant blade angle may be allowed for as limit values of the pitch drive. Here too, allowance may be made for example for when the optimum angle trajectory anticipated an acceleration of the pitch drive that this pitch drive cannot even achieve. In this second step, the optimum angle trajectory is therefore adapted in this sense. Once again, these are just two examples. Other further design criteria also come into consideration, such as for example a torsional vibration property of the rotor blade to be adjusted.

According to a further embodiment, it is proposed that each setpoint blade angle is determined in dependence on at least one further variable. Such a further variable may be the blade angle at the specific time of the rotor blade considered. Accordingly, the calculation of the setpoint blade angle also includes the actual blade angle. For example, in this way it can be avoided that an excessive deviation between the setpoint blade angle and the actual blade angle is specified. As a result, particularly the loading of the pitch drives can also be moderated.

An operating state of the pitch systems used may also be considered as a further variable. Preservation of the pitch drives can also be achieved in this way. Here, a pitch drive is part of a pitch system or the pitch drive may possibly also form the pitch system. For example, allowance may be made for the rate at which a pitch drive is making an adjustment just then, or whether it is making an adjustment at all just then. This may also include a temperature of the pitch drive or pitch system. Mechanical states of the blade drive may also be considered. This may include for example allowing for lubricating states of the blade mounting, the gear mechanism of the blade drive or other lubricated elements.

It is also proposed that, as a further variable, allowance is made for a sector size of a sector considered for the detected load torque. For this purpose, it is proposed that sectors are provided, for example 30°, 60° or 90° sectors of the rotor blade area, which the rotor blades pass over and in which an angle trajectory is calculated in each case. In this way, allowance can be made for certain fundamental conditions or relationships. For example, a small sector may be provided in the so-called 6 o'clock region, to be specific in the region in which the rotor blades pass the tower, and consequently a possible tower shadow. A different calculation specification for calculating the setpoint blade angle or the compensatory angle or the angle trajectory than in another region may be provided for this region. A larger sector may also be provided for example in an upper region, for example from a 10 o'clock position to a 2 o'clock position, because, although a comparatively high wind speed can be expected here, it scarcely changes from the 10 o'clock position to the 2 o'clock position because the height range of the rotor blade changes little there, whereas during the rotation of the aerodynamic rotor a rotor blade more rapidly increases its height position from an 8 o'clock position to a 10 o'clock position and more rapidly reduces its height position from a 2 o'clock position to a 4 o'clock position.

As a further variable, allowance may also be made for the load torque of a rotor hub. Here, in addition to the loading of the preceding rotor blade, allowance may therefore be made for a loading of the rotor hub. This may take place both directly, by a measurement at the hub, and indirectly, for example by estimating the hub loading on the basis of a blade loading. Correspondingly, in addition to a blade loading, allowance may also be made for a hub loading or a loading acting in some other way on the wind power installation and not only on the individual rotor blade. The detection and use of a rotor hub bending torque, which registers a bending of the hub or an element of the hub or at the hub, such as for example a bending of a journal that bears the hub, also comes into consideration.

As a further variable, allowance may also be made for a rotational rotor speed. For example, a sector size may be determined in dependence on the rotational rotor speed. It may be advantageous here to set larger sector sizes for higher rotational rotor speeds.

As a further variable, allowance may also be made for a rotor position. Thus, for example, position-dependent loadings or other influences, such as for example a tower shadow in a 6 o'clock position, may be included.

As a further variable, allowance may also be made for a rotor acceleration. This also includes of course a deceleration of the rotor, which is a negative rotor acceleration. Depending on the rotational rotor speed, which as mentioned can also be allowed for as a further variable, a positive rotor acceleration may be an indication of an impending excessive speed, and this should correspondingly also be allowed for in the determination of the setpoint blade angle such that it does not unnecessarily greatly promote the reaching of an excessive speed. Conversely, allowance may also be made for a deceleration of the rotor near to a lower rotational rotor speed, at which the wind power installation can still just about be operated, and correspondingly the setpoint blade angle may be chosen such that the rotor is not decelerated to an even greater extent, to name just one further example.

According to one embodiment, it is proposed that the at least one detected load torque and possibly the further variables for which allowance is made are included by way of weighting factors or weighting functions that can be set. As a result, the influence of the variable concerned, that is to say at least the detected load torque, can be influenced and also possibly adapted or changed by setting the weighting factors or weighting functions. The use of a weighting factor may be regarded here as a special case of the weighting function. A weighting function can be used to also make allowance for example for dynamics or nonlinearity. A weighting function may for example be a PT1 element, by way of which an alteration of the variable for which a weighted allowance is respectively to be made is included with a corresponding delay. The weighting function may for example also be a root function, by way of which the absolute value of the variable for which a weighted allowance is to be made is then included nonlinearly. Particularly, multiple variables can be included, and the weighting factors or the weighting functions can be used to have an influence on how great the respective influence of the respective variable is. This preferably takes place such that each of the further variables is respectively assigned one of the weighting factors or weighting functions that can be set. Each further variable for which allowance is made can consequently be set in the extent to which it is included by way of the weighting factor or weighting function assigned to it.

According to one embodiment, it is proposed that the weighting factors or weighting functions are chosen in dependence on the achievable reduction of the load, neutrality of the yield and preservation of the drive. Particularly in simulations or test measurements in field trials, it can be checked which variables influence the result of the control, how and to what extent. Depending on this, the weighting factors or the weighting functions are chosen, in order in this way to coordinate with one another the respective influences of the load torque of the preceding blade and the further variables for which allowance is made. As assessment criteria, allowance is made for the achievable reduction of the load, the achievable neutrality of the yield and the preservation of the drive. Preferably, these variables are compared by applying an assessment norm, for example by applying an H2 norm. It is therefore not only attempted to reduce the load or loading as much as possible but also attempted not to reduce the yield thereby, or to reduce it as little as possible, or even to improve it. Optimally, the yield is not reduced, so that a neutrality of the yield is achieved by the loading-reducing measure.

In addition, it is proposed to achieve greatest possible preservation of the drive. Therefore, allowance is also made for the degree to which the drives, also known as pitch drives, are loaded. Preferably, the compensatory angle is chosen such that the mean value of the compensatory angles of all of the rotor blades is zero. Preferably, that is not required for each sampling time, but on average over a longer time period. This can achieve the effect that the mean value of the setpoint angles corresponds to the basic angle. It is particularly also avoided that for example all of the angles of the rotor blades deviate from the basic angle in one direction, which leads as a result to a different overall aerodynamic situation of the rotor than was envisaged by specifying the basic angle. This counteracts the risk of the individual loading-dependent blade angle adjustment changing altogether the specification of the aerodynamic and control-related behavior of the wind power installation; at least it prevents it from being changed too much.

Also or alternatively, the compensatory angle is chosen such that the absolute value of each compensatory angle does not exceed a predetermined maximum angle. Also in this way it can be achieved that the basic angle is still substantially determinative for the overall operation of the wind power installation. Such a predetermined maximum angle may preferably assume a value of approximately 3°, 5° or 7°. These values can still permit an adjustment that makes it possible for the blade loading to be significantly relieved, but without the overall aerodynamic situation of the rotor changing too much.

According to one embodiment, it is proposed that at least two loading measurements with different loading directions are detected on each rotor blade and that the setpoint blade angles are determined such that a loading acting on the wind power installation is minimized such that a pitching moment and a yawing moment are minimized, at least are respectively reduced in their amplitude. By making allowance for at least two loading directions at each rotor blade, consequently not only an absolute value of the loading is detected, but also a direction of the loading. Such a direction of the loading may lead to a pitching moment progression with which the nacelle that bears the rotor therefore experiences a torque about a horizontal axis that is perpendicular to an axis of rotation of the rotor. A yawing moment, which refers to a torque that acts on the nacelle about a perpendicular axis, may also be produced. By corresponding direction-sensitive allowance for these blade loadings, such a pitching moment and/or such a yawing moment can also be minimized, or at least reduced, by the proposed individual blade adjustment. Particularly, amplitude fluctuations of the hub moments, especially in the pitching and yawing directions, can be allowed for and accordingly reduced. This is successfully achieved particularly by each rotor blade being individually adjusted such that each rotor blade contributes to reducing the amplitude of the pitching moment and/or yawing moment and these contributions of all of the rotor blades consequently being able to act together.

A further configuration proposes that, for detecting the load torques, a rotor area passed over by the rotor blades is divided into multiple sectors and the load torques are respectively recorded when a sector is passed over by a rotor blade and this is used for determining a partial trajectory for setpoint blade values of a following rotor blade. Preferably, the partial trajectory is made up of multiple interpolation points and, for this purpose, it is proposed as a preferred solution that, between the interpolation points, values of the partial trajectory are interpolated.

A phased detection of the load torques and determination of a trajectory for setpoint blade values is consequently proposed. A phased procedure can consequently be adopted; particularly, allowance can be made for different sectors of the rotor area and the manner of the allowance can also vary here from one sector to the next. This is also based on the realization that the wind and its properties can change within the rotor area, for example in a manner dependent on the height and/or dependent on the proximity to the tower of the wind power installation. At the same time, it has been recognized that a completely individual allowance for each rotor blade position may be too complex, at least may be disproportionate. It is correspondingly proposed to allow for such different characteristics of the wind in the rotor area by considering each sector in turn.

For this purpose, according to the proposal, load torques are recorded in each sector and converted into a partial trajectory or a portion of a trajectory. To be specific for a trajectory for setpoint blade values for the respectively following rotor blade. In this way consequently an individual allowance can be made at least for each sector in turn, while nonetheless producing an overall concept for the individual blade adjustment which to be specific is based on the trajectory or the partial trajectory. Preferably, it may be envisaged to adapt partial trajectories of neighboring sectors to one another in their transitional region such that even this transitional region is continuous, and in particular also continuously differentiable. In this way, an overall trajectory is then created.

That an overall trajectory is created does not mean however that it is already completely predetermined for an entire revolution. Rather, it is only ever one portion at a specific time that is determined. After all, the determination of a trajectory for a rotor blade takes place in dependence on the loading of the preceding rotor blade, so that expediently, as a maximum, a trajectory for 120° is completely predetermined. Nevertheless, however, neighboring trajectories are expediently placed one against the other in a continuous and in particular continuously differentiable manner. For example, a partial trajectory may be determined for a 60° sector, that is to say for example for an 8 o'clock position to 10 o'clock position. Following that, a new partial trajectory is determined for a next 60° sector, to be specific the position from 10 o'clock to 12 o'clock, and is placed against the previous partial trajectory. For the following rotor blade for which these partial trajectories were determined, this trajectory can then be gradually implemented; that is to say that the blade angles can then be gradually set in a way corresponding to the trajectory for setpoint blade angles.

Also within each sector, an implementation of the load torques can take place on the basis of interpolation points. Thus, for example, setpoint blade values of the partial trajectory to be created may be determined every 5°, to name one example, and put together to form the partial trajectory. If further values are required between these interpolation points, they can be interpolated, or such an interpolation or other implementation takes place in the implementation in which corresponding blade angles are set on the basis of the setpoint blade values of the partial trajectory.

Preferably, the division of the rotor area into sectors takes place in dependence on a detected or likely wind field in the region of the rotor area. If, therefore, different characteristics of the wind have been found in different regions of the rotor area, for example the wind is differently turbulent, allowance for that can be made here.

Preferably, a size and/or number of the sectors is chosen in a manner dependent on the wind field. In addition or as an alternative, the number of interpolation points of the partial trajectories may depend on the wind field. Particularly for more turbulent regions, a sector in which a comparatively high number of interpolation points can then also be provided may be provided. On the other hand, for a region in which the wind is more uniform, a further sector may be correspondingly provided, and it may additionally be provided in this sector that the interpolation points lie comparatively far apart; it may therefore be provided that comparatively few interpolation points are provided in this sector.

Particularly, a detected or likely gustiness may be a criterion for a wind field for which allowance is to be made. Preferably, therefore, the division of the rotor areas into sectors is performed in dependence on the gustiness of the different wind fields.

According to one configuration, it is proposed that the division of the rotor area into sectors, in particular the size and/or number of the sectors, is performed adaptively in the course of operation of the wind power installation. For this purpose, an adaptation algorithm may be provided, being given as input variables the input variables mentioned, or at least one of them, on which the division into sectors depends, and outputting particularly the size of the sectors and/or the number of sectors, preferably also the specific regions of the sectors. For example, criteria by way of which allowance is to be made for the variables for which an allowance is respectively to be made, that is to say as for example as described above, may be implemented in the adaptation algorithm. In addition, an asymptotically damped delay function, such as for example a PT1 element, may be provided for the adaptive changing of the respective sectors. Preferably, a sector is changed in each case immediately after it has just been allowed for in an individual blade adjustment.

According to one embodiment, it is proposed that multiple virtual rotor areas are defined. Such a virtual rotor area corresponds to the actual rotor area and is additionally characterized by at least one time value and/or an associated rotor revolution. Consequently taken as a basis is particularly the rotor area at the specific time, that is to say the rotor area that is just being passed over in one revolution, and additionally the rotor area of the previous revolution. Assuming that no adjustment or no significant adjustment of the azimuth position was performed in between, the two rotor areas are the same but have different properties, particularly different loading properties, particularly also in different sectors. As a result, a detection can consequently take place over multiple revolutions, and consequently also the rotor area of the previous revolution or previous revolutions can be considered. As a result, it can particularly also be assessed how good the calculated individual blade angle trajectory previously was and, depending on that, parameters can be set or adapted. Such parameters include a sector size to be chosen and pitch dynamics of the pitch systems to be set. If appropriate, drive limits may also be adapted, if it is found in these investigations that such drive limits are not expedient.

Correspondingly, according to one embodiment, it is proposed that a loading detection takes place over multiple revolutions, and the setpoint angle is additionally determined in dependence on the loading of at least one previous revolution.

According to a further configuration, it is proposed that each rotor blade considered is readjusted to its setpoint blade angle with specifiable setting dynamics, the setting dynamics being in particular PTn behavior with n≥1. Also or alternatively, a different asymptotically damped behavior may be provided for the setting dynamics. Accordingly, it is on the one hand proposed that the blade adjustment for the implementation of the setpoint value, that is to say particularly for the implementation of a corresponding trajectory, has certain properties. These properties are preferably chosen such that the pitch system is operated with little energy, but nevertheless high dynamics can be achieved. Particularly advantageous is PT1 behavior, which can be easily realized and has an asymptotic behavior. In order to achieve greater dynamics and also to be able to provide a more differentiated specification of the dynamics, setting dynamics of a higher order also come into consideration. What is more, the fact that such setting dynamics are specifiable means that they are also to be allowed for in the determination of the setpoint blade angle. Particularly, the trajectory can be specified such that these specifiable dynamics can also be maintained. It is consequently proposed that the trajectory is also determined dependent on specifiable setting dynamics.

According to one embodiment, it is proposed that the adjustment of the blade angle of each rotor blade considered, in particular also including the specification of the setpoint blade angle for the rotor blade considered in each case, takes place without feedback of a loading of the rotor blade considered. To this extent, control without feedback is carried out. In the simplest case, consequently, an adjustment of the rotor blade considered takes place just in dependence on the loading of the preceding rotor blade. In this way, for reducing the loading of the individual rotor blades, an individual blade adjustment that is specified individually for each rotor blade but without feedback of the loading of the same rotor blade can be proposed. As a result, oscillating behavior or even instabilities due to unfavorable feedback can particularly also be avoided. As a result, in turn a robust control can be achieved. This is so because, as a result, changes of the presumed controlled system are not directly fed back and, as a result, also cannot change a control circuit in an unforeseen way.

According to a further embodiment, it is proposed that the setpoint blade angle values are specified such that the pitching moment and the yawing moment are reduced in comparison with a setpoint angle without a compensatory angle, permitting an increase in a loading of the rotor blades. Here it has particularly been recognized that an individual blade adjustment should not necessarily have the sole objective of relieving the individual blades, but that the adjustment of individual rotor blades can influence both the pitching moment and the yawing moment. Since loadings on the rotor blade can in principle act on the pitching moment and yawing moment with very great leverage, it has been recognized that a reduction of the pitching moment and the yawing moment can have the effect of relieving the overall loading of the wind power installation at the cost of an increase in the loading of the rotor blades.

In this case, the pitching moment is a moment that exerts a tilting moment in the vertical direction on the rotor axis about which the rotor rotates. The yawing moment is a tilting moment that acts on the rotor axis of rotation in the horizontal direction.

According to one embodiment, the method is characterized in that the rotor has in its rotor area that is passed over by the rotor blades a center point of rotation, which forms a geometrical center point of the rotor area and about which the rotor rotates, the rotor has in its rotor area a load center point, which forms a center point of all of the loads acting on the rotor, and the method proceeds such that, even when the load center point deviates from the center point of rotation, the setpoint blade angles, in particular the compensatory angles, are determined such that the load center point substantially remains as constant as possible in its oscillating amplitude and is not necessarily brought to the center point of rotation. It is consequently proposed here that alternating load processes that occur at the load center point of the rotor are kept within limits in terms of their amplitude. It has been recognized that this can be achieved more easily if it is not explicitly attempted to displace the load center point in the direction of the center point of rotation of the rotor.

It is accordingly proposed that it is not explicitly attempted to displace the load center point but to avoid alternating loads. This can also avoid the need for the blades to carry out excessive cyclical adjusting movements during a revolution.

A wind power installation is also proposed and the wind power installation comprises an aerodynamic rotor with rotor blades that are individually adjustable in their blade angle, and wherein the rotor can be operated with a variable rotational rotor speed, a generator coupled to the aerodynamic rotor, for generating a generator output, a blade control device for individually adjusting each blade angle in a way corresponding to an individual setpoint blade angle, wherein each setpoint blade angle is made up of a common basic angle, which is specified for all of the rotor blades, and an individual compensatory angle, to allow for individual load torques, and the wind power installation also comprises a load detection unit for detecting in each case at least one load torque on each of the rotor blades, wherein, for each rotor blade considered, there is a preceding rotor blade and the setpoint blade angle of each rotor blade considered is determined in dependence on the at least one load torque of its preceding rotor blade. The load torque may for example be a bending torque.

The proposed wind power installation is consequently prepared in particular for carrying out a method for controlling a wind power installation according to at least one embodiment described. The blade control device may have a central control unit and pitch drives on each rotor blade and also be referred to synonymously as a blade control arrangement. The central control unit may particularly specify setpoint values or setpoint trajectories for the pitch drives, which the pitch drives then implement by adjusting rotor blades correspondingly.

The load detection unit particularly comprises at least one blade sensor, in particular at least one load sensor on each rotor blade, and as a result detects a loading. Each blade sensor is preferably formed as a strain sensor. Consequently, at least one blade sensor that transmits detected loadings to the blade control device, particularly to the central control unit, is provided for each rotor blade. Preferably, bending torques are detected, or derived from the measurements, as the loading or for the evaluation of the loading. Particularly, with knowledge of the component on which the strain was recorded, it is possible to derive bending torques from strains.

It is preferably provided that the load detection unit has at least one blade sensor on each of the rotor blades, in particular has at least two blade sensors on each rotor blade such that loadings in at least two directions can be detected on each rotor blade. The blade sensors may be formed as strain gages and they may be provided at a blade root or another point of the rotor blade. When multiple blade sensors are used for each rotor blade for detecting blade loadings in a number of directions, it is preferably proposed to arrange them offset by about 90° around the longitudinal axis of the rotor blade. Preferably, optical fibers are used as blade sensors, such as for example optical fibers that operate on the principle of the fiber Bragg grating.

### BRIEF DESCRIPTION OF THE SEVERAL VIEWS OF THE DRAWINGS

The invention is explained in more detail below by way of example on the basis of embodiments with reference to the accompanying figures.

FIG. 1 shows a wind power installation in a perspective view.

FIG. 2 shows a structural diagram on which the invention is based.

FIG. 3 shows a structural diagram of a proposed individual blade adjustment.

FIG. 4 shows a schematic representation of a load center point in a rotor area.

FIG. 5 shows part of a control structure, which may be part of the control structure according to FIG. 3.

FIG. 6 illustrates a partial aspect of a proposed method.

FIG. 7 illustrates possible loads acting on a wind power installation that may be influenced by a blade adjustment.

### DETAILED DESCRIPTION

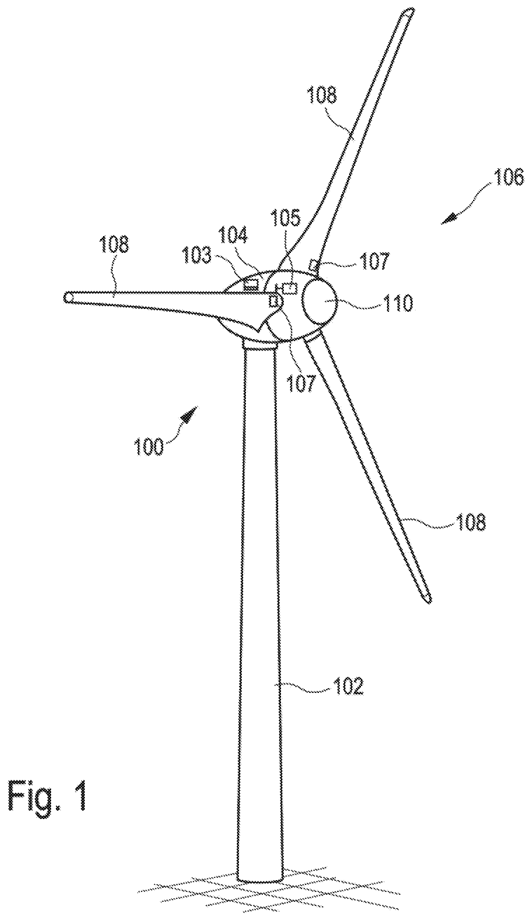

FIG. 1 shows a wind power installation 100 with a tower 102 and a nacelle 104.

Arranged on the nacelle 104 is a rotor 106 with three rotor blades 108 and a spinner 110. During operation, the rotor 106 is set in a rotary motion by the wind, and thereby drives a generator in the nacelle 104.

In the nacelle 104, a central control unit 103 may be provided. Adjusting drives 105, one of which is shown by way of example, are provided in the spinner 110 respectively in the region of each rotor blade 108 and, together with the central control unit 103, can form a blade adjusting device. Provided on the rotor blades 108 are three blade sensors 107 for determining loadings at the rotor blades 108, to be specific one on each rotor blade 108. The three blade sensors 107 can together form a load detection device or unit. The central control unit 103 may also be located on a rotor blade and rotate along with the rotor.

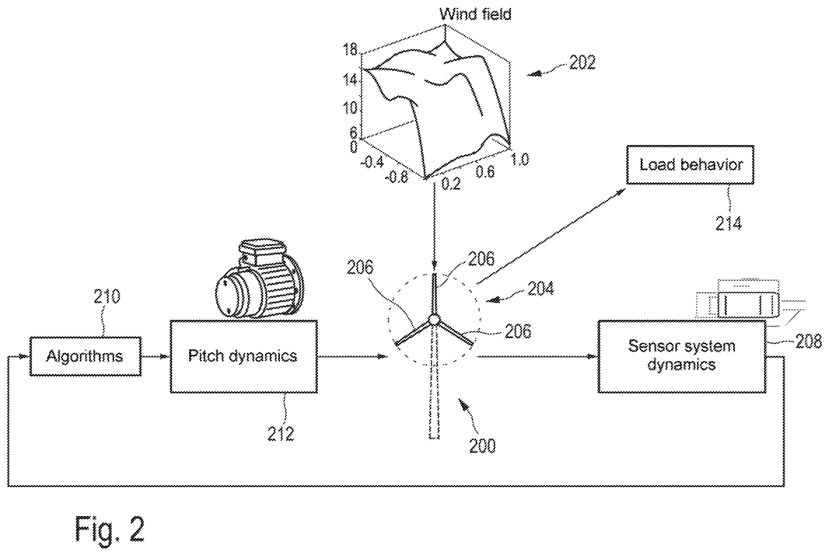

FIG. 2 illustrates in the simplified structure a wind power installation 200, on which a schematically indicated wind field 202 acts. Initially, this wind field 202 acts particularly on the rotor 204 of the wind power installation 200.

Particularly forces acting on the rotor blades 206, particularly also loads acting on them, can be detected by corresponding sensors. Such detection is subject to sensor dynamics, which are illustrated here by the sensor dynamics block 208.

The result of the detected forces, loads or other influences that are detected in the sensor dynamics block 208 is passed to a calculation block 210 of the central control unit 103, which calculates from it specification values, such as angle specifications, and among them particularly angle trajectory specifications. Such values can then be output as setpoint values. The calculation block 210 is only shown here as a block by way of representation, and concerns in particular any algorithms that are used for such a calculation.

Setpoint values calculated in the calculation block 210, particularly for blade angles to be set, are passed on to corresponding pitch drive systems. This is illustrated as a transfer to the pitch dynamics block 212, in order to illustrate that pitch dynamics exist between such setpoint blade angle values and the blade angles that are then actually established.

The output of this pitch dynamics block 212 then acts again on the wind power installation, particularly on the rotor 204 and its rotor blades 206. As a result, consequently these values for the blade angles that are generated by the pitch dynamics block 212 and the wind according to the wind field 202 act on the rotor 204 and its rotor blades 206. All of this then produces a load behavior, which for the sake of simplicity is depicted here for purposes of illustration as a load behavior block 214. Other variables also result of course, but the resultant loads or the resultant load behavior is/are of significance, so that this is illustrated here in the load behavior block 214.

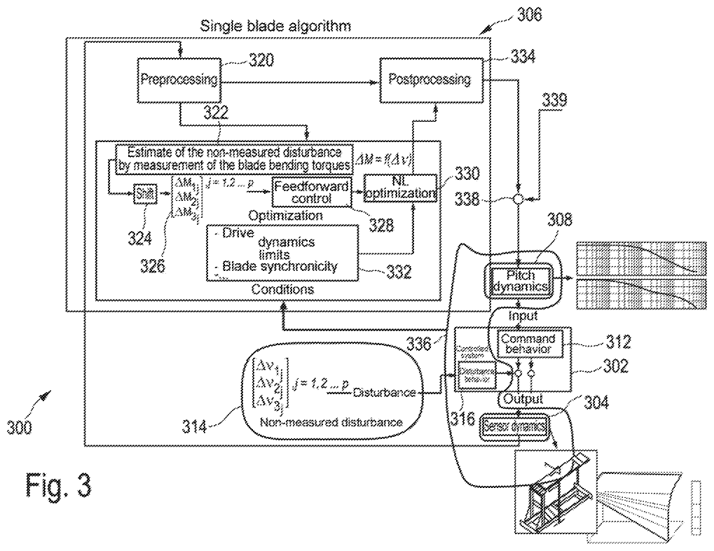

FIG. 3 shows details of an embodiment of a proposed control for individual blade adjustment in the overall structure 300, which forms the central control unit. The essential elements of this overall structure 300 are the controlled system 302, the sensor dynamics 304, the individual blade algorithm block 306, the pitch dynamics 308 and, in addition, the general blade adjustment 310.

The controlled system 302 stands for the behavior of the wind power installation that is relevant to the present consideration. This includes particularly the command behavior 312, which indicates how the wind power installation reacts to a command variable. This relates here particularly to the behavior of the wind power installation or its reaction to blade angle adjustments. The dynamics of the blade angle adjustment, that is to say the pitch dynamics 308, are allowed for here separately from the command behavior. Here, the output variable of the pitch dynamics 308 forms the input variable for the command behavior 312.

Furthermore, disturbances 314 also act on the wind power installation, to be specific particularly changes in speed or differences in speed in the wind speed, which are referred to here as Δv₁, Δv₂ and Δv₃. These disturbances 314 are not measured directly. However, the disturbance behavior 316 is known, or at least partially known, and if appropriate can be allowed for. The disturbances 314 therefore act by way of the disturbance behavior 316 on the controlled system, that is to say on the behavior of the wind power installation.

The result can be detected with the aid of sensors and is in this case changed by way of the sensor dynamics 304.

This output behavior of the controlled system 302, that is to say of the wind power installation, that is changed by the sensor dynamics 304 is sent or fed back to the individual blade algorithm block 306. Building on this, an individual blade adjustment can be specified or preplanned in the individual blade algorithm block 306. Preplanned should be understood here as meaning very short-term planning, to be specific in particular for a planning time period which is shorter than the time that the rotor 204 of the wind power installation requires to rotate further by one blade 206.

Furthermore, the individual blade algorithm block 306 makes allowance for properties of the pitch dynamics 308, the sensor dynamics 304 and the disturbance behavior 316, which is combined in the property group 336. The arrow indicated from this property group 336 to the individual blade algorithm block 306 is intended merely to indicate that allowance can be made specifically for these properties mentioned. It does not mean that they are always fed back there. Rather, they may be stored, and if appropriate updated, in the individual blade algorithm block 306.

First, a first evaluation of the values entered, that is to say the values that are obtained from the sensor dynamics 304, takes place in the process block 320. Among other things, bending torques can be extracted in the process block 320 and transferred to the estimating block 322. The estimating block 322 can estimate from the measured bending torques disturbances that are not measured. Also coming into consideration for this is to use a state observer. In this case, allowance can also be made for the disturbance behavior 316. Such disturbances that are not measured, which by way of illustration enter the disturbance behavior block 316 as disturbances 314, may particularly be wind variations, to be specific particularly changes of the wind speed and wind direction.

Particularly, in the estimating block 322 the disturbances that are not measured are estimated for each individual blade, that is to say are thereby detected. These results for the individual blades, such as for example the blades 206 according to FIG. 2, are fed to the shift block 324. The shift block 324 ensures that the disturbances of individual blades detected in this way are in each case provided or used for a following blade. Proposed for this are shift and assignment operations, which may be implemented as a linked sequence of mathematical transformations. One result is a torque block 326, which in each case contains a differential torque, to be specific a differential bending torque for each rotor blade. Such a differential bending torque is the difference between the estimated bending torque of the respective rotor blade and a mean value of the estimated bending torques of all three rotor blades.

In the torque block there are consequently different torque vectors, which to be specific respectively comprise three elements, that is to say one element for each rotor blade. Multiple vectors are provided here, because these torque values are not constant and change over the rotor area, particularly as a result of the movement of the rotor blades due to rotation of the rotor. In principle, a continuous torque vector with continuously changing differential bending torques may also be used, but in terms of control technology this is scarcely implementable, particularly when using a digital computer. It has also been found that such a theoretical continuous implementation is not required.

The output of the torque block 326 is then passed to the precontrol block 328. The precontrol block 328 can consequently specify part of a blade angle or a change of a blade angle or a blade angle difference for each blade in the sense of a feedforward compensation. This corresponds in principle to the individual compensatory angle, apart from the fact that the latter can still be changed further.

This precontrol block 328 alone can in this case specify for each rotor blade an angle trajectory for a phase of movement of the rotor blade over the rotor area, for this part of the angle, differential angle or change of angle. For example, an angle trajectory may be specified for a rotor blade for its movement from a 12 o'clock position to a 2 o'clock position, while this is specified for a further blade for a region from the 4 o'clock position to the 6 o'clock position. In this example, both angle trajectories respectively concern a region of 60°. However, other regions, that is to say other sectors of the rotor area, may also be taken as a basis. In this case, these sectors may also respectively differ in their size from one blade to the other.

The result of the precontrol according to the precontrol block 328 is then fed to the nonlinear optimization block 330. In the nonlinear optimization block 330, the angles that the precontrol block 328 has created and produced can be further adapted while still making allowance for constraints. Such constraints are fed to the nonlinear optimization block 330 from the constraint block 332. Such constraints may be for example the dynamics of the pitch drive, limits of the pitch drive or a blade synchronicity. The blade synchronicity makes allowance as a constraint for the fact that the rotor blades 206, though individually adjusted, are nevertheless coordinated with one another overall in their adjustment. Particularly, the mean value of the blade angles is intended to correspond to the basic angle. In this case, it is sufficient that this is satisfied in the long term. It does not have to be satisfied at every sampling time, but instead the intention is simply to prevent that the blade angles diverge permanently, which could happen for example as a result of rounding errors.

The constraints for which allowance is made in the constraint block 332 are consequently particularly drive dynamics and limits of the pitch drives and the blade synchronicity mentioned. Allowance may be made for other constraints.

With this adaptation of the blade angles or blade angle trajectories in the nonlinear optimization block 330, they can be fed to the postprocessing block 334. In the postprocessing block 334, if appropriate still further adaptations may be performed. Particularly, a trajectory may be finally checked in the postprocessing block 334, particularly for plausibility and implementing practicality. It may be checked whether the respective trajectory can be valid, for example whether it lies within predetermined limits and/or can be put together with a previous trajectory, to name just two examples. Also or alternatively, angle values to be set in actual fact at the specific time can be derived in the postprocessing block in dependence on the rotational speed or rotor position. Each angle trajectory is an angle progression in dependence on the rotational angle, and consequently the angle to be set in each case at a particular moment and/or the portion of a trajectory to be used at a particular moment depends on the actual position of the rotating rotor. The actual angle values can consequently be determined while making allowance for the rotor position at the specific time, and consequently the rotor blade position at the specific time. Alternatively or in addition, this may be determined by making allowance for the rotational rotor speed. This can be performed in the postprocessing block 334. In this case, the postprocessing block 334 may output actual angles, that is to say setpoint angles, instead of angle trajectories. Finally, these compensatory angles are added to a basic angle 339 in the summing element 338. This basic angle 339 can be specified in the usual way.

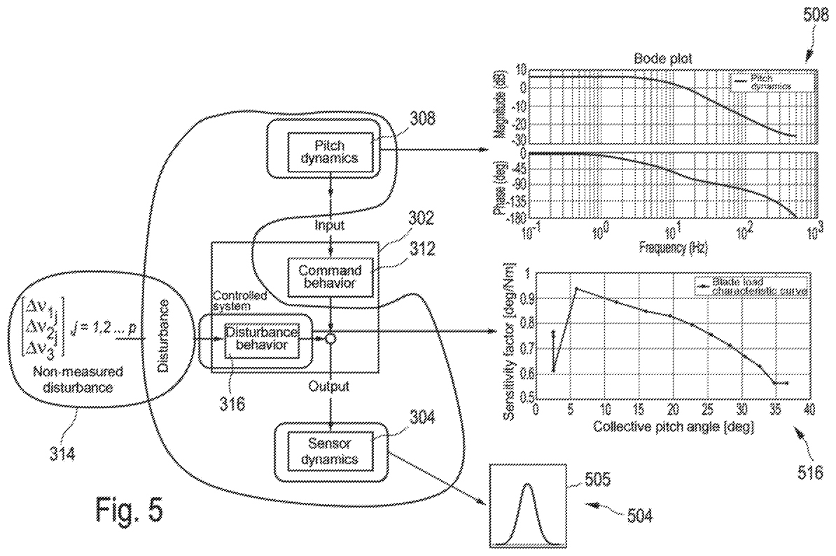

FIG. 5 shows a detail of FIG. 3, to be specific of the controlled system 302 with upstream pitch dynamics 308 and downstream sensor dynamics 304. The controlled system 302 comprises the command behavior 312 and the disturbance behavior 316, by way of which the disturbances 314 act on the controlled system 302.

In FIG. 5 it is particularly intended to illustrate that the pitch dynamics 308, the sensor dynamics 304 and the disturbance behavior 316 are relevant properties for the control structure. The respective dynamics are illustrated here.

For the pitch dynamics 308, a schematic Bode plot 508 is used to show that the pitch dynamics have essentially second-order low-pass characteristics.

For the disturbance behavior, it is illustrated by a disturbance diagram 516 that there is an angle-dependent sensitivity. The disturbance diagram shows here a sensitivity factor, which is plotted in a normalized form on the y axis over a collective pitch angle of 0°-40°, the characteristic curve extending from 2°-37°. The sensitivity factor indicates here by how many degrees (°) the blade must be turned out of the wind in order to counteract a bending torque as loading. With a blade angle of 6°, the blade must therefore be turned further out of the wind by over 10° in order to reduce a flexural loading of approximately 0.9 pu. This flexural loading can be reduced in the case of a blade angle of 35° by a further turning movement out of the wind by less than 7°.

The collective pitch angle is the average pitch angle for which allowance is made.

It is consequently evident that the sensitivity essentially decreases with increasing blade angles. With greater blade angles, the blade is therefore less susceptible to disturbances. In the example shown, the maximum value is obtained however at 6°. What is decisive here however is that such a disturbance behavior does exist and allowance can be made for it, particularly for the individual blade algorithm, particularly in the individual blade algorithm block 306. This is so because the disturbances cannot be measured, or are not measured, but it is nevertheless known how strong their influence can be in dependence on the blade angle. Consequently, on the one hand the disturbance can be inferred on the basis of the blade angle and a detected bending torque, on the other hand the bending torque for the following blade can be better inferred on the basis of the detected disturbance, to put it clearly at least as an estimate.

Therefore, while making allowance for the disturbance sensitivity, particularly the sensitivity factor, which relates to the blade load or a flexural loading, the disturbance can be estimated from the flexural loading of the preceding blade. Then, while making allowance for the disturbance sensitivity, particularly the sensitivity factor, this estimated disturbance can be used to derive the flexural loading of the following rotor blade that runs after this preceding rotor blade.

For the sensor dynamics 404, a sensor diagram 504 that is intended particularly to illustrate the complexity of the sensors is presented. Particularly indicated is a part-diagram 505, which particularly illustrates the variance of such a sensor or of such sensors.

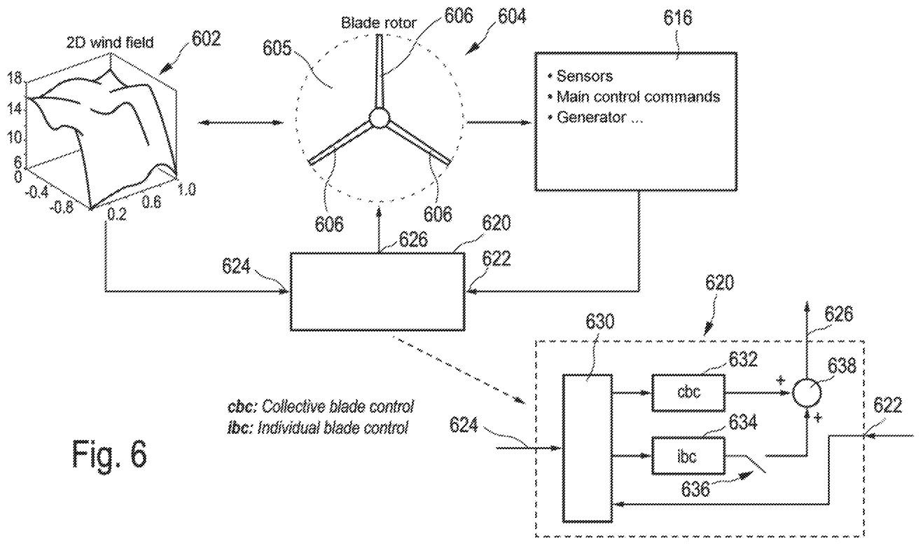

Furthermore, FIG. 6 schematically illustrates that there is a relationship between the rotor 604 with its rotor blades 606 and the illustrated wind field 602. Moreover, the rotor area 605 is also depicted as a circle.

It is illustrated in the main block 616 that this is influenced by the rotor 606 or that, overall, control actions for the wind power installation can be derived from it. By way of example, it should be pointed out that this main block 616 may comprise sensors, in order to detect states of the rotor such as for example the rotational rotor speed. A main control, which can control the wind power installation, is also operated in a manner dependent on these states. In particular, it may also depend on the rotational speed of the rotor. It may, however, also make allowance for blade angles, to mention a further example. The generator may also be controlled in manner that is also dependent on the rotor or its behavior, such as for example dependent on the detected rotational rotor speed.

A resultant control measure is to activate a pitch system 620 from this main block 616. For this purpose, the pitch control 620, shown by way of example, provides a main input 622. Furthermore, the wind field 602 acts on the pitch control 620, which is illustrated by way of the load input 624. Particularly this feedback of the wind field 602 should be understood as an illustration of individual loads that are not homogeneous in the rotor field 605.

The pitch control 620 then has a pitch outlet 626, which acts on the rotor blades 606 and consequently on the rotor 604, to be specific provides individual blade adjustments, at least specifies for them corresponding setpoint blade angles. These setpoint blade angles are preferably specified as angle trajectories.

The pitch control 620 is also shown enlarged with its main input 622, its load input 624 and its pitch output 626.

The pitch control 620 shows in its enlargement a pitch control block 630, which obtains both variables from the main control, that is to say the main block 616, and load variables by way of the load input 624. This is used to determine a basic angle in the basic angle block 632 and an individual compensatory angle for each rotor blade in the individual angle block 634. These two angles can be added in the summing element 638 to form a setpoint blade angle.

With the switch 636, the pitch control 620 provides the possibility that the compensatory angle that is determined in the individual angle block 634 is not provided as feedforward compensation. In this case, the basic angle determined by the basic angle block 632 then already corresponds to the setpoint angle. In this case, the angles of all three rotor blades 606 are also the same. Consequently, this switch 636 provides an easy way of deactivating an individual blade adjustment when it is evident that it is likely to have little effect. Particularly in situations where the wind is weak, it may be envisaged to open this switch 636, as represented in FIG. 6, in order thereby to deactivate the individual blade adjustment.

It should in this case be remembered that, in a situation with weak wind, the optimization calculations nevertheless calculate compensatory angles or compensatory angle trajectories. Although these are likely to be only small as a result of the solution to an optimization problem while making allowance for boundary conditions, they would nevertheless lead to an unnecessary activation of the pitch drives. This can be prevented by the switch 636. The switch can be switched in a manner dependent on wind speeds or else in a manner dependent on other states of the wind power installation, such as for example the rotational rotor speed. It also comes into consideration to use a result of the individual blade algorithm, for example the size of calculated compensatory angles, as a criterion for the switch 636.

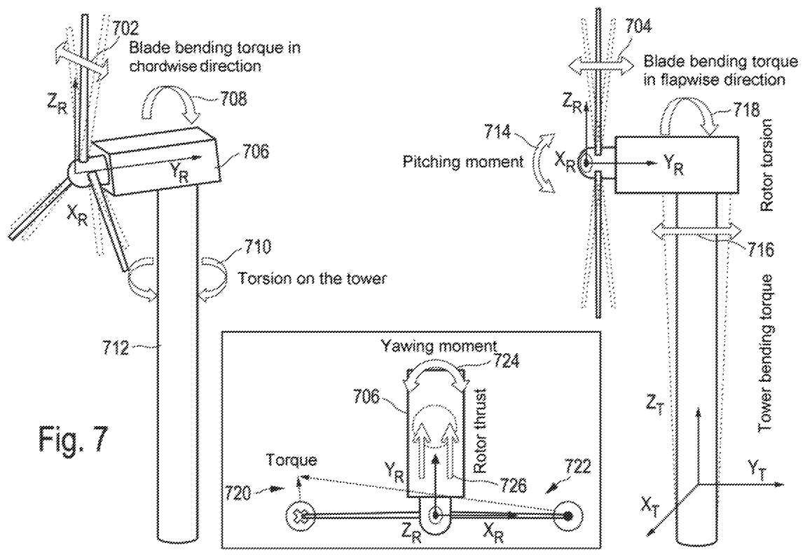

FIG. 7 particularly shows various loadings, which can occur particularly also due to a non-homogeneous wind field. Initially, blade bending torques may be produced in the chordwise direction, illustrated by the reference sign 702 or the blade bending torque arrow in the chordwise direction 702. Blade bending torques may also occur in the flapwise direction 704.

It is illustrated in the representation on the left that particularly blade bending torques in the chordwise direction 702 may lead to a chordwise movement 708 of the nacelle 706 about its horizontal axis. A torsional movement 710 of the tower 712 also comes into consideration.

Particularly the bending torques in the flapwise direction 704 may lead to a pitching moment 714, which is illustrated in the right-hand part of FIG. 7. A tower bending torque 716 may also occur here, and also a rotor torsion 718.

In the middle diagram of FIG. 7, it is also illustrated that a torque 720 can act on the rotor 722. Furthermore, a yawing moment 724 may occur, which is a torque that acts on the nacelle 706 about its perpendicular axis. Lastly, a rotor thrust 726 may also occur, which represents an axial loading on the rotor.

Otherwise indicated for purposes of illustration and orientation are the three Cartesian force directions X_{R}, Y_{R} and Z_{R} possibly acting on the rotor. Likewise for orientation, the three Cartesian directions X_{T}, Y_{T} and Z_{T} are indicated.

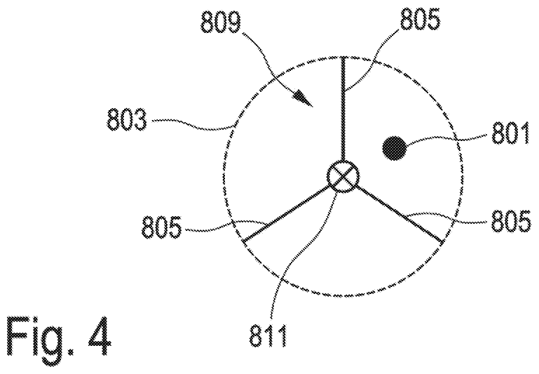

FIG. 4 shows a schematic representation of a load center point 801 in a rotor area 803. The rotor area 803 is the area that is passed over by the rotor blades 805 of the rotor 809. The rotor 809 has a center point of rotation 811, which is also the geometrical center point of the rotor 809. The load center point 801 deviates in FIG. 8 from the center point of rotation 811. Although it could be regarded as optimum when the load center point 801 always coincides with the center point of rotation 811, it has been recognized that it is often better to operate the wind power installation such that the load center point remains as constant as possible in terms of its amplitude. This is so because it has been recognized that this avoids alternating loads, which can sometimes represent a greater loading than absolute loading caused by the load center point 801 deviating from the center point of rotation 811. It has in this respect also been recognized that a corresponding individual blade adjustment can be used to achieve the effect of keeping the load center point 801 substantially constant with respect to the center point of rotation.

1. A method for controlling a wind power installation, wherein the wind power installation has an aerodynamic rotor with a plurality of rotor blades having individually adjustable blade angles, wherein the aerodynamic rotor is configured to be operated with a variable rotational rotor speed, and wherein the wind power installation has a generator coupled to the aerodynamic rotor for generating a generator output, the method comprising:
individually adjusting each blade angle in a way that corresponds to an individual setpoint blade angle, wherein each setpoint blade angle depends on:
a common basic angle, which is specified for all of the plurality of rotor blades, and
an individual compensatory angle that compensates for individual load torques,
detecting in each case at least one load torque or a variable indicative of the at least one load torque on each of the plurality of rotor blades,
wherein for each rotor blade determining the setpoint blade angle in dependence on the at least one load torque of a preceding rotor blade.

2. The method as claimed in claim 1, further comprising determining the individual compensatory angle includes determining an angle trajectory, wherein each compensatory angle is an element of the angle trajectory, so that the angle trajectory respectively indicates a continuous progression of the respective compensatory angle.

3. The method as claimed in claim 2, wherein the angle trajectory is determined in at least first and second steps, wherein:
in the first step, an optimum angle trajectory that is optimized with respect to at least one or more first design criteria is determined, and
in the second step, the optimum angle trajectory determined in the first step is altered to an adapted angle trajectory, while making further allowance for one or more second design criteria.

4. The method as claimed in claim 2, wherein the angle trajectory is determined by way of a solution to an optimization problem on a basis of the at least one or more first design criteria.

5. The method as claimed in claim 1, wherein each setpoint blade angle is chosen in dependence on at least one:
an initial blade angle,
blade bending torques,
operating state of pitch systems used,
sector size of a sector considered for the at least one detected load torque,
load torque of a rotor hub,
rotor hub bending torque,
rotational rotor speed,
rotor position, or
rotor acceleration.

6. The method as claimed in claim 3, wherein the at least one or more first design criteria is at least one of:
reduction of the load,
neutrality of yield, or
preservation of a pitch drive,
wherein the one or more second design criteria is at least one of:
drive dynamics of the pitch drive, or
limit values of the pitch drive.

7. The method as claimed in claim 6, wherein the at least one detected load torque or other variables are weighting factors or weighting functions.

8. The method as claimed in claim 7, wherein the weighting factors or weighting functions are chosen in dependence on a reduction of the load, neutrality of the yield, and preservation of the pitch drive.

9. The method as claimed in claim 1, wherein the compensatory angle is chosen such that at least one of:
a mean value of the compensatory angles of all of the rotor blades is zero; or
an absolute value of each compensatory angle does not exceed a predeterminable maximum angle.

10. The method as claimed in claim 1, wherein at least two loading measurements with different loading directions are detected on each rotor blade, and wherein the setpoint blade angles are determined such that a loading acting on the wind power installation is minimized such that at least one of: a pitching moment or a yawing moment are reduced.

11. The method as claimed in claim 1, wherein detecting the at least one load torque or a variable indicative of the at least one load torque on each of the plurality of rotor blades includes:
dividing a rotor area passed over by the rotor blades into multiple sectors, and
recording the load torques when a sector is passed over by a rotor blade, and using the recorded load torques to determine a partial trajectory for setpoint blade values of a following rotor blade.

12. The method as claimed in claim 11, wherein dividing the rotor area into multiple sectors takes place in dependence on a detected wind field in a region of the rotor area, such that at least one of:
a size or number of the sectors is chosen in a manner dependent on the detected wind field, or
a number of interpolation points of the partial trajectory depends on the detected wind field.

13. The method as claimed in claim 11, wherein dividing the rotor area into sectors is performed adaptively during of operation of the wind power installation.

14. The method as claimed in claim 1, wherein multiple virtual rotor areas are defined, wherein each virtual rotor area corresponds to the actual rotor area and is additionally comprising at least one time value and/or an associated rotor revolution.

15. The method as claimed in claim 1, wherein a loading detection takes place over a plurality of revolutions of the aerodynamic rotor, and wherein the setpoint blade angle additionally depends on the loading that occurs during at least one previous revolution.

16. The method as claimed in claim 1, wherein each rotor blade is readjusted to its setpoint blade value with specifiable setting dynamics, the setting dynamics having at least one of: PTn behavior with n being equal to or greater than 1 or a different asymptotically damped behavior.

17. The method as claimed in claim 1, wherein individually adjusting each blade angle takes place without feedback of a loading of the respective rotor blade.

18. The method as claimed in claim 1, wherein values of the setpoint blade angle are specified such that a pitching moment and a yawing moment are reduced in comparison with a setpoint angle without a compensatory angle, permitting an increase in a loading of the rotor blades.

19. The method as claimed in claim 1, wherein:
the rotor has a rotor area that is passed over by the rotor blades and has a center point of rotation, which forms a geometrical center point of the rotor area and about which the rotor rotates, and
the rotor has in its rotor area a load center point, which forms a center point of all of the loads acting on the rotor, and
wherein the method further comprises such that when the load center point deviates from the center point of rotation, the setpoint blade angles are determined such that the load center point substantially remains constant with respect to its oscillating amplitude and is not brought to the center point of rotation.

20. A wind power installation, comprising
an aerodynamic rotor configured to be operated with a variable rotational rotor speed;
a plurality of rotor blades coupled to the aerodynamic rotor, wherein the plurality of rotor blades have individually adjustable blade angles; and
a generator coupled to the aerodynamic rotor, the generator being configured to generate a generator output,
a load detecting unit for detecting at least one load torque on each of the rotor blades;
a blade control device for individually adjusting each blade angle in a way corresponding to an individual setpoint blade angle, wherein each setpoint blade angle is determined based on:
a common basic angle, which is specified for all of the rotor blades,
an individual compensatory angle, to allow for individual load torques, and
at least one load torque of a preceding rotor blade.

21. A wind power installation performing the method as claimed in claim 1.

22. The wind power installation as claimed in claim 20, wherein the load detecting unit includes at least one blade sensor on each of the rotor blades.

23. The method as claimed in claim 11, wherein the partial trajectory is made up of a plurality of interpolation points, wherein between the interpolation points, values of the partial trajectory are interpolated.
